(19) United States
(12) Patent Application Publication
(10) Pub. No.: US 2008/0274313 A1
(43) Pub. Date: Nov. 6, 2008

(54) TEAR STRIP AND A METHOD FOR PROVIDING SAME

(75) Inventor: Jurgen Hanten, Bad Nauheim (DE)

Correspondence Address: HAHN LOESER & PARKS, LLP, One GOJO Plaza, Suite 300, AKRON, OH, 44311-1076, US

(73) Assignee: POLY-CLIP SYSTEM GMBH & CO. KG, Frankfurt/Main (DE)

(21) Appl. No.: 12/112,167

(22) Filed: Apr. 30, 2008

(30) Foreign Application Priority Data
May 4, 2007 (DE) 102007021048.7-27

(51) Int. Cl. A22C 13/00

(52) U.S. Cl. 428/34.8

(57) ABSTRACT

A sausage-shaped product, in particular a sausage product, made of a protective casing and a viscous or granular filling material, in particular sausage meat, which is accommodated inside the protective casing. The protective casing being formed from a flat web material which is shaped into a tube closed at both ends and has longitudinal edges contacting or overlapping one another. It is further provided that at least one tear strip is affixed to the protective casing in the region of the contacting or overlapping longitudinal edges.

### BACKGROUND OF THE INVENTION

The invention relates to a sausage-shaped product comprising a protective casing and a viscous and pasty or liquid or granular filling material accommodated in the protective casing, in particular a sausage product, and a method for simplifying the removal of the protective casing enclosing a viscous and pasty or liquid or granular filling material to form a sausage-shaped product, in particular for sausage products.

Sausage-shaped products according to the invention can be products in which the filling material is a chemical composition, such as an adhesive or a sealing compound. Similarly, the sausage-shaped products can be foodstuffs in which the protective casing encloses sausage meat or some other food.

Such sausage-shaped products often have the disadvantage that the protective casing cannot be easily opened and removed from the filling material without using a suitable tool, such as a knife. However, in various everyday situations, such a tool is not available in many cases.

A sausage-shaped product of the kind initially specified is known from U.S. Pat. No. 3,528,601, in which the protective casing is formed from a flat web material, which is shaped into a tube closed at both ends and has longitudinal edges overlapping one another. The overlapping longitudinal edges of the flat web material are joined by welding them together. On the outer side of the protective casing, outside the region of the two longitudinal edges welded together, a tear strip extending transversely to the longitudinal axis of the sausage-shaped product is disposed. A larger section of the tear strip is securely welded to the protective casing, whereas the remaining section is not joined to the protective casing. To open the protective casing, the tear strip is gripped at the free end, which is not welded to the protective casing, and pulled, whereupon the protective casing is supposed to tear open.

This known solution has the disadvantage that pulling the tear strip depends for success on the material of the protective casing. If the material is merely single-layered, then the tear strip known from U.S. Pat. No. 3,528,601 can indeed cause the protective casing to open. However, if the protective casing is made of a laminate film, providing the tear strip in the manner of the prior art can lead to only the topmost layer of the laminate being detached from the protective casing when the tear strip is pulled off, but with the protective casing itself remaining intact. There is then no longer a way of opening the protective casing further.

### SUMMARY OF THE INVENTION

An object of the present invention is to provide a sausage-shaped product and a method of the kind initially specified that allows the protective casing to be opened without the aid of tools, irrespective of the material from which the casing is made.

What is proposed, more particularly, is a sausage-shaped product comprising a protective casing and a viscous or granular filling material accommodated therein, such as a sausage product, where the protective casing is formed from a flat web material that is shaped into a tube closed at both ends and has longitudinal edges contacting or overlapping one another. By affixing at least one tear strip to the protective casing in the region of the contacting or overlapping longitudinal edges, use is made of the fact that the joint between the two longitudinal edges in such a sausage-shaped product constitutes a weakness in the structure of the protective casing. Affixing the tear strip in the region of said joint allows the protective casing to be reliably broken open and removed from the filling material, irrespective of the material selected for the protective casing.

Depending of the choice of material intended for the protective casing, providing the tear strip in the aforementioned manner may suffice. However, if the material of the protective casing has a high strength, for example because it is embodied as a laminate, then it may be advantageous if the protective casing is provided with a material weakening in the immediate vicinity of the tear strip. This material weakening is used to facilitate the tearing of the protective casing when pulling the tear strip. The protective casing can also be made easier to break open by providing the protective casing with a material weakening on at least one side, preferably on both sides of the tear strip, and in the immediate vicinity thereof.

A wide variety of solutions can be provided for the material weakening itself. One preferred option consists in the material weakening in the protective casing being formed by a slit or a perforation. The slit, for its part, can come in a wide variety of forms. It may suffice, for example, that the slit is embodied as an incision applied substantially perpendicularly to a longitudinal edge of the protective casing. Another possibility is that the slit is a V-shaped notch along one longitudinal edge of the protective casing. Irrespective of its particular form, the slit extends advantageously from the respective longitudinal edges into the interior of the protective casing. The length of the slit or slits is preferably in the range between 0.1 mm and 3 mm.

The tear strip may be disposed on the protective casing in different orientations. One option is that the tear strip is provided on the protective casing in such a way that it extends in the circumferential direction at least approximately perpendicularly to the longitudinal axis of the sausage-shaped product. In order for the protective casing to be torn open reliably, it is advantageous when the length of the tear strip is greater than the width of overlap of the overlapping longitudinal edges of the protective casing. This ensures that, when the protective casing is torn open by means of the tear strip, the weakness in the protective casing along the weld seam, the width of which generally corresponds to the width of overlap of the overlapping longitudinal edges, is used to open the protective casing. The tear strip can be provided with a greater length of up to an at least approximately complete encirclement of the sausage-shaped product in the circumferential direction. In other words, the tear strip extends in this case from one longitudinal edge to the other longitudinal edge of the flat web material, plus a portion which protrudes over a longitudinal edge and can be used to grip the strip when opening the protective casing.

As has already been mentioned, there is the possibility in the case of sausage-shaped products to join the two longitudinal edges of the flat web material not only overlappingly, but also to use a connecting strip that covers the two abutting longitudinal edges of the flat web material. The latter is also referred to as an abutting strip seal. This connecting strip is likewise joined to the longitudinal edges of the protective casing by means of a welding, heat-sealing or bonding process. In this arrangement of the tear strip substantially transverse to the longitudinal axis of the sausage-shaped product, the length of the tear strip should advantageously be greater than the width of the connecting strip.

In addition to arranging the tear strip in a direction that is transverse or perpendicular to the longitudinal axis of the sausage-shaped product, there is also the possibility of attaching the tear strip to the protective casing in such a way that it extends in the longitudinal direction of sausage-shaped product. This is advantageous in the case of the abutting strip seal, in particular, i.e., when the longitudinal edges are arranged adjacent each other and are joined to each other by a connecting strip that is attached to the abutting longitudinal edges by a heat-sealing, welding or gluing process. Here, too, advantage is taken of the fact that the connecting strip by means of which the two longitudinal edges of the protective casing are joined together is a weakness in the protective casing. In this case, the width of the tear ship should advantageously be greater than the width of the connecting strip.

In the embodiment described in the previous paragraph, the tear strip is laid over the two abutting longitudinal edges, preferably in a region close to the end of the sausage. When securely sealing the connecting strip, the tear strip is likewise attached to the sausage-shaped product. However, due to the fact that the tear strip is wider than the connecting strip, only that part of the tear strip, which is covered by the connecting strip, is securely welded to the protective casing and/or to the two abutting longitudinal edges of the protective casing. The two sections that project beyond the width of the connecting strip to the right and left, seen from the longitudinal axis of the center strip, are not securely joined to the protective casing by any of the aforementioned methods of attachment, in contrast. Hence, these edges can be gripped, and the protective casing can be opened. This is particularly easy when the sausage end adjacent to the tear strip is severed. The tear strip can then be gripped from above at both projecting ends and pulled away in the direction of the longitudinal axis of the sausage-shaped product, whereupon the protective casing tears open in the region of the connecting strip. As already mentioned, the protective casing can also be opened in the region of the connecting strip without cutting off the end of the sausage, by gripping the two projecting ends pointing in the direction of that end of the sausage close to the tear strip.

In the case of a sausage product in which the longitudinal edges of the protective casing overlap, the protective casing can be opened in a particularly reliable manner by disposing the tear strip between the two overlapping longitudinal edges of the protective casing in such a manner that it protrudes therebetween. In other words, the tear strip is applied to the outer side of the flat web material intended for the protective casing, in the region of one of the two longitudinal edges, before the tube is formed by means of a heat-sealing, gluing or welding process. Of course, the tear strip may also be provided on the inner side of the flat web material provided for the protective casing, particularly when the longitudinal edges of the flat web material are overlapped in such a way that the section of flat web material on whose inner side the tear strip is to be attached comes to rest over the other section of flat web material. In this case, the tear strip is arranged in such a way that the tear strip extends from at least approximately at the longitudinal edge of the flat web material to which it is attached in the direction of the other longitudinal edge, wherein a portion of the tear strip from the end facing said longitudinal edge to the middle thereof, for example, is welded, glued or sealed to the flat web material, whereas the other portion pointing in the direction of the other longitudinal edge of the flat web material is freely movable. After forming the tube and overlapping the other longitudinal edge of the flat web material over the longitudinal edge to which the tear strip is fixed, the tear strip which is not glued, welded or sealed to the flat web material protrudes to the outside and can be used to tear or break open the protective casing.

Of course, this solution can also be used in cases where the tear strip is disposed in the axial direction or at least approximately parallel to the longitudinal axis of the sausage-shaped product. In such a case, the tear strip is securely welded by means of the connecting strip to the longitudinal edges of the flat web material, i.e. parallel thereto, in the region of the longitudinal edges. In contrast to the variant described in the foregoing, however, the tear strip protrudes over the longitudinal edges of the connecting strip.

If the sausage-shaped product is closed at its ends by closure means, with the protective casing being gathered at its ends to form tresses, then it may also be advantageous when the tear strip, if oriented substantially parallel to the longitudinal axis of the sausage-shaped product, is disposed under the connecting strip in a region immediately following the transition from the gathered end of the sausage-shaped product to the section of the product having a uniform diameter or calibre. If, for example, the tress-like or gathered end of the product is cut off, those parts of the tear strip protruding on one or both sides over the longitudinal edges of the connecting strip, in particular the corners of the strip pointing in the direction of the severed end of the sausage, can be gripped in order to open the protective casing.

The tear strip can essentially be attached not only to the outer side of the protective casing, but also to the inner side of the protective casing, as described above.

The same material as the protective casing may be chosen for the tear strip, or the tear strip may be produced from a material which is different to that of the protective casing.

A wide range of different material can be used for the protective casing. It is particularly advantageous when the protective casing is made from a plastic flat web material. In this case, the plastic flat web material has at least one layer. A particularly preferred embodiment is one in which the protective casing is made of a plastic laminate flat web material.

The tear strip can be attached using all possible attachment methods. For example, the tear strip can be attached to the protective casing by heat-sealing, welding or by gluing it thereto.

To make the tear strip easily identifiable for the user, the tear strip can also be provided in such a way that it is distinguishable by its color both from the filling material and from the protective casing.

It should also be noted that the width of the tear strip can basically be chosen according to requirements. It is possible, for example, to provide a very wide tear strip that can therefore be visually identified with ease, or to make the tear strip very narrow and to reduce it to such a size that the tear strip becomes a tear thread. However, such a tear strip extends not only in two dimensions, but extends in all three dimensions and for that reason can also be easily felt inside the protective casing, which is advantageous when visibility conditions are poor.

What is proposed, in particular, is a method for simplifying the removal of the protective casing that encloses a viscous or granular filling material to form a sausage-shaped product, in particular the protective casing of sausage products, in order to expose the filling material, wherein the protective casing is formed from a flat web material which is shaped into a tube closed at both ends and which has longitudinal edges contacting or overlapping one another. More particularly, at least one tear strip is attached to the protective casing in the region of the contacting or overlapping longitudinal edges.

The same advantages apply in respect of said method as have been described in the foregoing. It should be remarked, in addition, that the inventive method can be used to advantage particularly when the protective casing in the form of a tube of flat web material is not formed until just before the filling operation. In such a case, the tear strip can be applied to the flat web material along the longitudinal edges thereof in clocked cycles and in predefined intervals, before the two longitudinal edges are finally joined—be it by overlapping the two longitudinal edges and then welding, heat-sealing or gluing them together, or by arranging the two longitudinal edges adjacent each other and joining them together by means of a connecting strip that is attached to the two longitudinal edges by means of a heat-sealing, welding or gluing process. Both options for orienting the tear strip—transversely or parallel to the longitudinal axis of the sausage-shaped product—are possible here.

### DESCRIPTION OF THE DRAWINGS

Other advantageous configurations and two embodiments of the sausage-shaped product shall now be described with reference to the Figures. Attention should be drawn in this regard to the fact that the terms “left”, “right”, “bottom” and “top” used to describe the drawings relate to the drawings oriented in such a way that the reference numerals and figure references are readable in a normal way. In the drawings,

FIG. 1A shows a plan view of a sausage-shaped product comprising a tear strip oriented transversely to the longitudinal axis of the sausage-shaped product;

FIG. 1B shows a cross-section through the sausage-shaped product shown in FIG. 1A, along line I-I; and

FIG. 2 shows a plan view of a sausage-shaped product comprising a tear strip oriented parallel to the longitudinal axis of the sausage-shaped product.

### DETAILED DESCRIPTION OF THE DRAWINGS

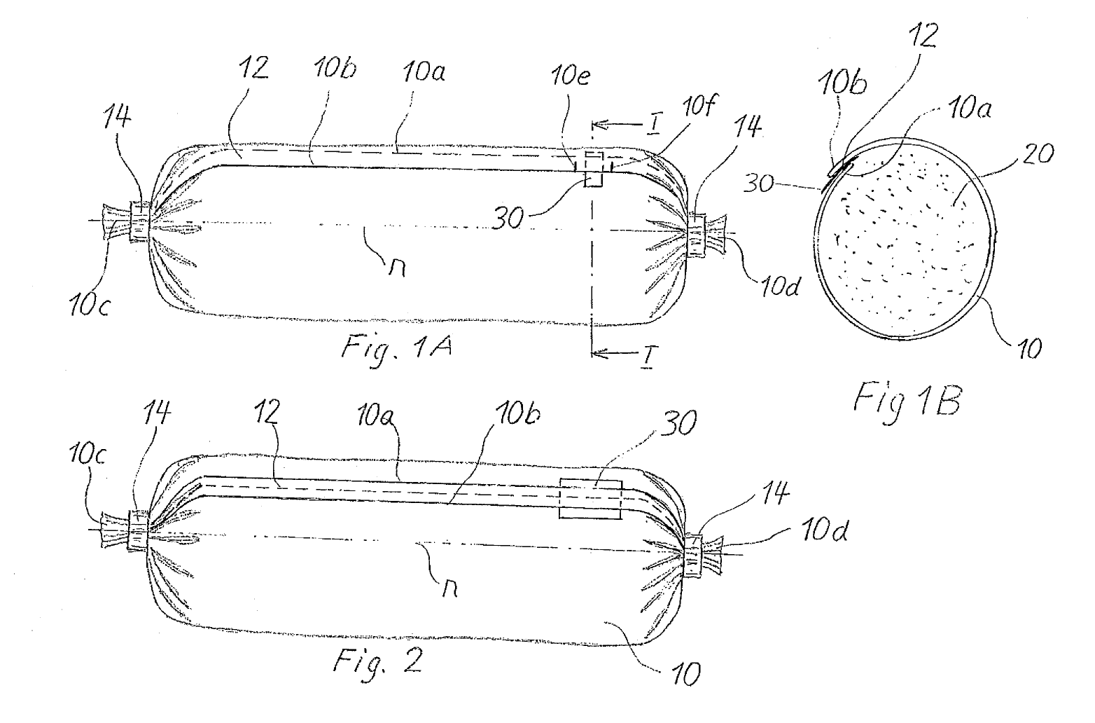

In the two embodiments shown in FIGS. 1A, 1B and 2 and described below, the sausage-shaped product according to the invention is a sausage product. The sausage product consists of a protective casing 10 and a filling material 20, which is a sausage meat. Protective casing 10 is produced from a plastic laminate flat web material in such a way that the two longitudinal edges 10a, 10b of the flat web material are shaped into a tube with overlapping longitudinal edges 10a, 10b. The two longitudinal edges 10a, 10b are securely joined to each other along a connecting seam 12 which is produced by means of heat-sealing, welding or gluing.

As can be seen from FIGS. 1A and 2, protective casing 10 is gathered to a tress at its two ends 10c, 10d and closed by a closure means in the form of a clip 14. Said two ends can be referred to as the sausage ends.

In the embodiment according to FIGS. 1A and 1B, a tear strip 30 is disposed transversely or perpendicularly to the longitudinal axis M of the sausage-shaped product, i.e., such that tear strip 30 extends in the circumferential direction around the sausage-shaped product. As can be seen from FIG. 1b, tear strip 30 is placed between the two overlapping longitudinal edges 10a, 10b of protective casing 10 in such a way that it protrudes therebetween. In particular, one portion of tear strip 30 protrudes between the overlapping longitudinal edges 10a, 10b of protective casing 10, whereas the other portion thereof extends in the opposite direction, likewise between the overlapping longitudinal edges 10a, 10b, into the interior of protective casing 10. This latter portion of tear strip 30 is securely joined to protective casing 10 at least partially by a joining method, for example a heat-sealing, welding or gluing method. The former portion of tear strip 30 is not joined to protective casing 10 and can therefore be gripped by a user of the sausage-shaped product in order to tear open protective casing 10.

As can be seen from FIGS. 1A and 1B, the length of tear strip 30 is greater than the width of the joining seam 12. The width of tear strip 30 itself is selected such that it can be reliably and securely gripped with at least two fingers of a human hand, i.e., between the thumb and index finger, for example.

As can also be seen from FIG. 1A, protective casing 10 is provided at longitudinal edge 10b, which lies opposite longitudinal edge 10a, in the vicinity of which tear strip 30 is securely joined to protective casing 10, with two incisions 10e, 10f on either said of tear strip 30. These two slits 10e, 10f, which extend from longitudinal edge 10b at least approximately in a direction perpendicular to longitudinal edge 10b and about 0.1 mm to 3 mm into the interior of protective casing 10, are used to ensure reliable tearing and hence opening of protective casing 10 when the freely grippable end of tear strip 30 is pulled accordingly.

In order to apply tear strip 30 to protective casing 10, the tear strip 30 is attached by the aforementioned attachment method to the outer side of protective casing 10 in the region of the one longitudinal edge 10a of protective casing 10 before the tube is formed. The section of tear strip 30 which is securely attached by the attachment method to protective casing 10 is disposed at longitudinal edge 10a or close thereto. The other end of tear strip 30, which later protrudes freely between the overlapping longitudinal edges 10a, 10b of protective casing 10, as shown in FIG. 1B, points in the direction of the other longitudinal edge 10b of protective casing 10. By means of an attachment method, the portion of tear strip 30 whose end points to the nearby longitudinal edges 10a of protective casing 10 is then attached to protective casing 10 by means of said attachment method. Simultaneously or previously or thereafter, the two slits 10e, 10f are formed in the flat web material along longitudinal edge 10b. The flat web material is then formed into a tube, the other longitudinal edge 10b of protective casing 10 being laid over the longitudinal edge 10a which is provided with tear strip 30. In the next step, the two longitudinal edges 10a, 10b of the flat web material are securely joined to each other by means of an attachment method such a heat-sealing, welding or gluing. It should be noted in this connection that it is also possible for tear strip 30 to be merely laid upon the flat web material and not be securely joined thereto until the two longitudinal edges 10a, 10b of the protective casing 10 are joined to the outer and inner sides, respectively, of protective casing 10.

Another embodiment is shown in FIG. 2, in which tear strip 30 is oriented in the axial direction, i.e., parallel to longitudinal axis M of the sausage-shaped product. In this case, tear strip 30 is laid over the two abutting longitudinal edges 10a, 10b of protective casing 10 in the region of the right-hand sausage end. Of course, the tear strip may already have been attached by means of heat-sealing, welding or gluing to the longitudinal edges 10a, 10b that it covers, but at least one and preferably two portions of the strip, which protrude to the left and right from the longitudinal axis of connecting strip 12 beyond said subsequently applied connecting strip 12, are not attached to protective casing 10. Irrespective of whether tear strip 30 is merely laid over the two abutting longitudinal edges 10a, 10b or has already been attached to same, tear strip 30 is covered by connecting strip 12, which is laid over the two longitudinal edges 10a, 10b along the entire length of the sausage-shaped product, and which is preferably made of the same material as protective casing 10. By joining this connecting strip 12 and the two longitudinal edges 10a, 10b by means of heat-sealing, welding or gluing, tear strip 30 is likewise joined to protective casing 10 and in particular to the two longitudinal edges 10a, 10b thereof. As can be seen from FIG. 2, tear strip 30 has a larger width than connecting strip 12 and therefore protrudes with its two longitudinal edges beyond connecting strip 12. Since tear strip 30 is joined to connecting strip 12 at the two longitudinal edges 10a, 10b of protective casing 10 or in regions immediately adjacent thereto, the two protruding portions of strip 30 are not securely attached to the protective casing. Hence, these portions can be gripped in order to break open protective casing 10. It is also possible that the right-hand end of the sausage in FIG. 2 is cut off in the region of tear strip 30, preferably at the right-hand edge thereof, or through tear strip 30 itself, so that the two protruding portions of tear strip 30, particularly the corners of tear strip 30 pointing in the direction of the severed sausage end, can then be gripped from above and the protective casing 10 broken open.

As already mentioned, it can be seen from FIG. 1A that two material weakenings 10e, 10f used to facilitate tearing open protective casing 10 are introduced on either side of tear strip 30 into longitudinal edge 10b, which covers tear strip 30 and the other longitudinal edge 10a. Such material weakenings may also be provided, but are not shown, in the embodiment in FIG. 2.

It should also be noted that, in both embodiments, tear strip 30 is produced from the same material as the protective casing 10.

1. A sausage-shaped product made of a protective casing and a viscous or granular filling material within the protective casing, comprising:
the protective casing being formed from a flat web material shaped into a tube closed at both ends and having longitudinal edges contacting or overlapping one another; and
at least one tear strip affixed to the protective casing in the region of the contacting or overlapping longitudinal edges.

2. The sausage-shaped product of claim 1, where the protective casing has at least one material weakening in the immediate vicinity of the tear strip, and the protective casing has said at least one material weakening on at least one side of the tear strip and in the immediate vicinity thereof.

3. The sausage-shaped product according of claim 1, where the tear strip extends in the circumferential direction at least approximately perpendicularly to a longitudinal axis of the sausage-shaped product.

4. The sausage-shaped product of claim 1, where the tear strip extends in the longitudinal direction of the sausage-shaped product.

5. The sausage-shaped product of claim 1, where the tear strip is positioned between the two overlapping longitudinal edges of the protective casing, the tear strip protruding therebetween.

6. The sausage-shaped product of claim 1, where the tear strip is the same material as the protective casing.

7. The sausage-shaped product of claim 1, where the tear strip is heat sealed to the protective casing.

8. The sausage-shaped product according of claim 1, where the tear strip is a tear thread.

9. A method for simplifying the removal of the protective casing enclosing a viscous or granular filling material to form a sausage-shaped product in order to expose the filling material, the method comprising the steps of:
forming the protective casing from a flat web material into a tube closed at both ends and having longitudinal edges contacting or overlapping one another; and
affixing at least one tear strip in the region of the contacting or overlapping longitudinal edges.

10. The method of claim 9, further comprising the steps of:
providing the protective casing with at least one material weakening at least on one side of the tear strip and in the immediate vicinity thereof.

11. The method of claim 9, where the step of affixing at least one tear strip includes applying the tear strip to the protective casing such that it extends in the circumferential direction at least approximately perpendicularly to the longitudinal axis of the sausage-shaped product.

12. The method of claim 9, where the step of affixing at least one tear strip includes applying the tear strip to the protective casing such that it extends in the longitudinal direction of the sausage-shaped product.

13. The method of claim 9, where the step of affixing at least one tear strip includes providing the tear strip from the same material as the protective casing.

14. The method of claim 9, where the step of affixing at least one tear strip includes affixing the tear strip to the protective casing by heat sealing.
